(19) United States
(12) Patent Application Publication
(10) Pub. No.: US 2009/0282961 A1
(43) Pub. Date: Nov. 19, 2009

(54) Tape dispenser with cutter

(76) Inventors: Jeffrey M. Jones, Tigard, OR (US); Michael D. Jones, Tigard, OR (US)

Correspondence Address: ROBERT D. VARITZ, P.C., 4915 S.E. 33RD PLACE, PORTLAND, OR, 97202, US

(21) Appl. No.: 12/152,984

(22) Filed: May 19, 2008

(51) Int. Cl. B26D 7/06

(52) U.S. Cl. 83/436.5

(57) ABSTRACT

A dispenser for dispensing material includes a dispenser housing having a material track therein. A dispenser/cutter mechanism contained within the housing includes a trigger handle for activating the dispenser/cutter mechanism. The trigger handle is spring-biased to a non-compressed position, and is shiftable to a tape-cutting position and to a compressed position. A dispensing roller is activated by the trigger handle. A dispensing pawl is operatively located between the trigger handle and the dispenser roller, and the material is trained over the dispenser roller and is moved thereover by the action of the trigger handle. An anti-rebound pawl holds the dispensing roller in a fixed position when the trigger handle is moved to its compressed position. A cam-activated cutting blade is activated by the trigger handle when the trigger handle is moved to its tape-cutting position.

### FIELD OF THE INVENTION

This invention relates to dispensers, and specifically to a dispenser suitable for use with flexible tape of the type used to hang water pipes and electrical conduits.

### BACKGROUND OF THE INVENTION

Metal “plumbers tape” has been used for many decades to hold water pipes and electrical conduits in place in building structures. This tape is typically formed into long rolls, about one inch wide, and has perforations spaced along the length thereof at approximately one-inch intervals. The metal tape requires use of fairly heavy snippers to cut the tape to a desired length, which cutting results in rather sharp edges, which are conducive to scratching a users hands. Such tape has been replaced by a polymer version thereof, which is easier to work with and which is considerably cheaper. The polymer tape, which may be a monolithic structure or may be a woven nylon, also comes in long rolls, and has perforations spaced along its length. While the polymer tape is less likely to injure a user, and is much easier to cut, it tends to un-coil and tangle, resulting in user frustration, and wastage of material.

### SUMMARY OF THE INVENTION

A dispenser for dispensing material includes a dispenser housing having a material track therein. A dispenser/cutter mechanism contained within the housing includes a trigger handle for activating the dispenser/cutter mechanism. The trigger handle is spring-biased to a non-compressed position, and is shiftable to a tape-cutting position and to a compressed position. A dispensing roller is activated by the trigger handle. A dispensing pawl is operatively located between the trigger handle and the dispenser roller, and the material is trained over the dispenser roller and is moved thereover by the action of the trigger handle. An anti-rebound pawl holds the dispensing roller in a fixed position when the trigger handle is moved to its compressed position. A cam-activated cutting blade is activated by the trigger handle when the trigger handle is moved to its tape-cutting position.

It is an object of the invention to provide a dispenser for plastic plumbers' tape which will contain a roll of tape, and dispense and cut the tape.

Another object of the invention is provide a holder for a coil of plumbers' tape which will prevent un-coiling of the tape, thereby conserving the tape and reducing wastage.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a perspective view of the tape dispenser of the invention, with portion broken away to show detail.

FIG. 2 is a side elevation of the tape dispenser, with the trigger handle thereof shown in a compressed position.

FIG. 3 is a side elevation of the tape dispenser, with the trigger handle thereof shown in a tape-cutting position.

FIG. 4 is a side elevation of the tape dispenser, with the trigger handle thereof shown in a non-compressed position.

### DETAILED DESCRIPTION OF THE PREFERRED EMBODIMENTS

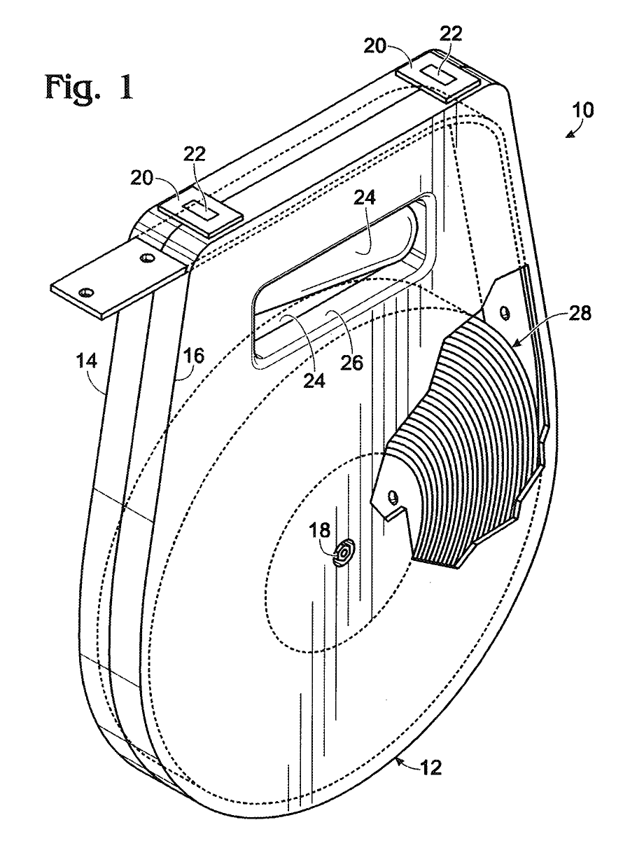

Referring now to the FIGS. 1-4, a tape dispenser constructed according to the invention is depicted generally at 10. The dispenser includes a clam-shell like case 12 including shell halves 14 and 16, which are held together by a fastener, such as nut-and-bolt combination 18. Case half 14 includes holders 20, which receive tabs 22 of case half 16 to further stabilize the case halves relative one another. Openings 24, 26 are provided in case halves 14, 16, respectively, to allow gripping of dispenser 10, and also to allow access to the dispensing mechanism of the dispenser.

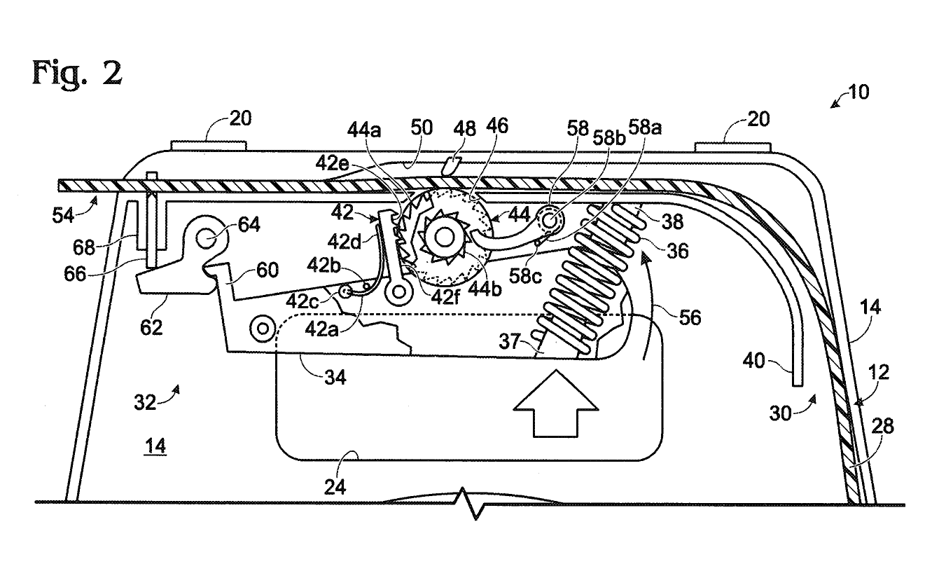

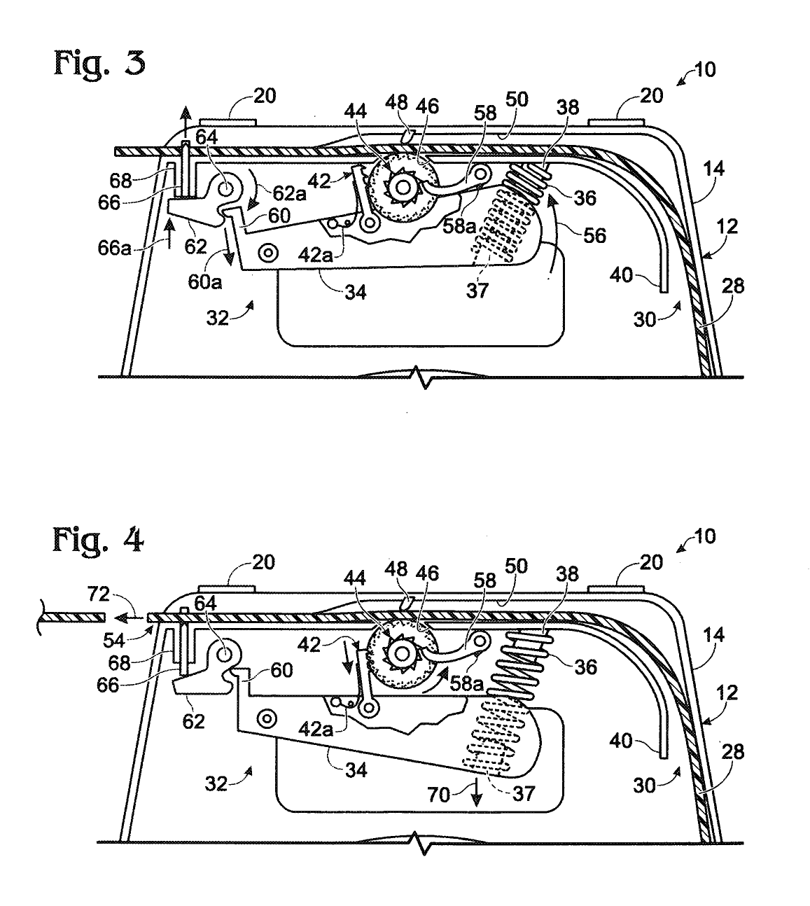

A roll of polymer plumbers' tape 28, also referred to herein as material or dispensed material, is placed in case 12 and threaded through a material track 30 therein, after which, the halves are fastened together. As previously noted, the tape may be an injection molded solid, or may take the form of a woven material. Case 12 contains a dispenser/cutter mechanism, shown generally at 32. Mechanism 32 includes a trigger handle 34, captured in case 12 and extending into opening 24, 26. Trigger handle, simply referred to herein as a trigger, 34 is biased to an extended, or non-compressed, position by a spring 36, which extends between trigger 34, held by a lower spring-capture element 37 and an upper spring-capture element 38, located under a lower track guide 40. Trigger 34 has a generally u-shaped cross section, for receiving other elements of the dispensing/cutter mechanism therein, such as spring 36 and lower spring-capture element 37. As will become apparent later herein, trigger 34 is shiftable between its extended, non-compressed, rest position, shown in FIG. 4, and a compressed position, shown in FIG. 2, and further to a tape-cutting position, shown in FIG. 3. Between its compressed position and its non-compressed position, trigger 34 passed through a tape-dispensing condition, which condition is achieved by the action of spring 36, also referred to herein as a trigger spring-biasing mechanism.

Trigger 34 is operable to move a dispensing pawl 42 against a dispensing roller 44, which extends through an opening 46 in lower track guide 40. Roller 44 may be fabricated with a somewhat rough surface to provide frictional contact between roller 44 and tape 28. A pressure plate 48 is located adjacent a case inner surface 50, which forms an upper track guide. Pressure plate 48 may be formed of a somewhat flexible material, to maintain tape 28 in frictional contact with roller 44. Upper track guide 50 and track guide 40 comprise track 30. Tape 28 is threaded through track 30 and between roller 44 and pressure plate 48, and exits dispenser 10 through an opening 54 at the end of track 30.

Roller 44 may be seen to include two sets of teeth formed thereon, with a first tooth set 44a being located on one side of roller 44 and a second tooth set 44b being located on the other side of roller 44.

Referring now to FIG. 2, trigger 34 is squeezed to a compressed position, in the direction of arrow 56, which moves dispensing pawl 42 upwards on first tooth set 44a of roller 44, which is prevented from moving in a clockwise direction by an anti-rebound pawl 58, which acts on second tooth set 44b. Both pawls 42 and 58 are spring-biased to their active positions by springs 42a, 58a, respectively, which allow the pawls to flex away from their respective tooth sets when required. Spring 42a wraps about a pin 42b and a stop 42c, having a free end thereof 42d operatively contacting dispensing pawl 42. It should also be noted that dispensing pawl 42 has a toothed portion 42e and a tooth-free portion 42f, which are explained later herein. Spring 58a is fixed in the inside of case half 14, wraps around pawl pin 58b, and has a free end 58c operatively in contact with anti-rebound pawl 58. From the position shown in FIG. 2, trigger 34 may be further compressed, into a tape-cutting position, shown in FIG. 3, or to a non-compressed position, shown in FIG. 4. Movement between either the compressed position or the tape-cutting position to the non-compressed position will result in trigger 34 passing through a tape-dispensing condition, wherein roller 44 is activated.

Referring initially to FIG. 3, further upward compression of trigger 34, in the direction of arrow 56, causes a lever 60, which, in the preferred embodiment, is integrally formed with trigger 34, to move in the direction of arrow 60a, to work a cam 62, which rotates, in the direction of arrow 62a, about a cam pin 64, and move a cam-activated cutting blade 66 upwards, in the direction of arrow 66a, in a cutting blade slot 68, extending cutting blade 66 into track 30, and cutting tape 28.

Referring now to FIG. 4, releasing trigger 34 allows spring 36 to move trigger 34 away from its tape-cutting position, in the direction of arrow 70, to its non-compressed position, passing through its tape dispensing condition. However, dispensing pawl 42 would activate roller 44, which would cause tape 28 to move in the direction of arrow 72, which would result in a jam in track 30, as cutting blade 66 is still at least partially extended into track 30. Thus, the non-toothed portion of pawl 42 merely slides along teeth 44a, not rotating roller 44 until toothed portion 42e contacts tooth set 44a, which happens after cutting blade 66 is fully retracted into slot 68. Tape 28 is then moved along track 30 in the direction indicated by arrow 72. Trigger 34 may be squeezed as often as required to move tape 28 through opening 54 at the end of track 30, passing through its tape-dispensing condition on each downward movement of trigger 34 in the direction of arrow 70. At this point, the trigger may continue to be squeezed to dispense tape, or the free end of the tape may be grasped and pulled out of dispenser 10 until the desired length of tape is free of the dispenser, shifting between non-compressed and compressed positions, passing through a tape-dispensing condition on each release of trigger 34. Trigger 34 may then be squeezed to a cutting position, fully activating cam 64, thus cutting the tape.

Thus, a dispenser/cutter for plumbers' tape has been disclosed. It will be appreciated that further variations and modifications thereof may be made within the scope of the invention as defined in the appended claims.

We claim:

1. A dispenser for dispensing material from a roll, comprising:
a dispenser housing having a material track and material contained therein; and
a dispenser/cutter mechanism contained within said housing, wherein said dispenser/cutter mechanism includes:
a trigger handle for activating the dispenser/cutter mechanism, wherein said trigger handle is spring-biased to a non-compressed position, and is shiftable to a tape-cutting position and a compressed position;
a dispensing roller activated by said trigger handle;
a dispensing pawl operatively located between said trigger handle and said dispenser roller, wherein the material is trained over said dispenser roller and is moved thereover by the action of the trigger handle;
an anti-rebound pawl for holding said dispensing roller in a fixed position when said trigger handle is moved to its compressed position; and
a cam-activated cutting blade, activated by said trigger handle when said trigger handle is moved to its tape-cutting position.

2. The dispenser of claim 1 wherein said dispensing roller includes a first tooth set on one side thereof and a second tooth set on the other side thereof, and wherein said dispensing pawl operatively engages said first tooth set and wherein said anti-rebound pawl operatively engages said second tooth set.

3. The dispenser of claim 2 wherein said dispensing pawl includes a toothed portion and a tooth-free portion, both of which contact said first tooth set of said dispensing roller, and wherein, when said trigger handle is shifted between its tape-cutting position and its compressed position, the tooth-free portion of said dispensing pawl moves over said first tooth set of said dispensing roller, and wherein when said trigger handle is shifted between its compressed position and its non-compressed position, it passed through a material-dispensing condition wherein the toothed portion of said disperser pawl engages said first tooth set, thereby rotating said dispenser roller and moving the material along said material track in the dispenser.

4. The dispenser of claim 2 wherein said cam-activated cutting blade is activated when said trigger handle is moved to its cutting position, wherein a lever on the trigger handle activates a cam which in turns moves a cutter blade in a cutter slot, whereby the cutter blade enters and passes through said material track, thereby cutting the material in the material track.

5. A dispenser for dispensing material from a roll, comprising:
a dispenser housing having a material track and material contained therein; and
a dispenser/cutter mechanism contained within said housing, wherein said dispenser/cutter mechanism includes:
a trigger handle for activating the dispenser/cutter mechanism, a spring for spring-biasing said trigger handle to a non-compressed position, and wherein said trigger handle is shiftable to a tape-cutting position and a compressed position, and wherein, when passing between said compressed position and said non-compressed position, said trigger handle passes through a material-cutting condition;
a dispensing roller activated by said trigger handle;
a dispensing pawl operatively located between said trigger handle and said dispenser roller, wherein the material is trained over said dispenser roller and is moved thereover by the action of the trigger handle;
an anti-rebound pawl for holding said dispensing roller in a fixed position when said trigger handle is moved to its compressed position; and
a cam-activated cutting blade, activated by said trigger handle when said trigger handle is moved to its tape-cutting position.

6. The dispenser of claim 5 wherein said dispensing roller includes a first tooth set on one side thereof and a second tooth set on the other side thereof, and wherein said dispensing pawl operatively engages said first tooth set and wherein said anti-rebound pawl operatively engages said second tooth set.

7. The dispenser of claim 6 wherein said dispensing pawl includes a toothed portion and a tooth-free portion, both of which contact said first tooth set of said dispensing roller, and wherein, when said trigger handle is shifted between its tape-cutting position and its compressed position, the tooth-free portion of said dispensing pawl moves over said first tooth set of said dispensing roller, and wherein when said trigger handle is shifted between its compressed position and its non-compressed position, it passed through a material-dispensing condition wherein the toothed portion of said dispenser pawl engages said first tooth set, thereby rotating said dispenser roller and moving the material along said material track in the dispenser, wherein said trigger handle is activated through its tape-dispensing condition solely by action of said spring for spring-biasing.

8. The dispenser of claim 6 wherein said cam-activated cutting blade is activated when said trigger handle is moved to its cutting position, wherein a lever on the trigger handle activates a cam which in turns moves a cutter blade in a cutter slot, whereby the cutter blade enters and passes through said material track, thereby cutting the material in the material track.

9. A dispenser for dispensing material from a roll, comprising:
a dispenser housing having a material track and material contained therein; and
a dispenser/cutter mechanism contained within said housing, wherein said dispenser/cutter mechanism includes:
a trigger handle for activating the dispenser/cutter mechanism, wherein said trigger handle is spring-biased to a non-compressed position, and is shiftable to a tape-cutting position and a compressed position;
a dispensing roller activated by said trigger handle, wherein said dispensing roller includes a first tooth set on one side thereof and a second tooth set on the other side thereof and wherein said dispensing pawl operatively engages said first tooth set and wherein said anti-rebound pawl operatively engages said second tooth set;
a dispensing pawl operatively located between said trigger handle and said dispenser roller, wherein the material is trained over said dispenser roller and is moved thereover by the action of the trigger handle;
an anti-rebound pawl for holding said dispensing roller in a fixed position when said trigger handle is moved to its compressed position; and
a cam-activated cutting blade, activated by said trigger handle when said trigger handle is moved to its tape-cutting position, wherein a lever on the trigger handle activates a cam which in turns moves a cutter blade in a cutter slot, whereby the cutter blade enters and passes through said material track, thereby cutting the material in the material track.

10. The dispenser of claim 9 wherein said dispensing pawl includes a toothed portion and a tooth-free portion, both of which contact said first tooth set of said dispensing roller, and wherein, when said trigger handle is shifted between its tape-cutting position and its compressed position, the tooth-free portion of said dispensing pawl moves over said first tooth set of said dispensing roller, and wherein when said trigger handle is shifted between its compressed position and its non-compressed position, it passed through a material-dispensing condition wherein the toothed portion of said dispenser pawl engages said first tooth set, thereby rotating said dispenser roller and moving the material along said material track in the dispenser.
